(19) United States
(12) Patent Application Publication
(10) Pub. No.: US 2013/0171608 A1
(43) Pub. Date: Jul. 4, 2013

(54) Learning toy with sounds

(71) Applicants: Janaki Ram SrinivasaRao Chetlapalli, Irvine, CA (US); Sreepranav Chetlapalli, Irvine, CA (US)

(72) Inventors: Janaki Ram SrinivasaRao Chetlapalli, Irvine, CA (US); Sreepranav Chetlapalli, Irvine, CA (US)

(21) Appl. No.: 13/342,973

(22) Filed: Jan. 4, 2012

(51) Int. Cl. A63H 33/42; G09B 25/00; A63H 33/26

(52) U.S. Cl. 434/365; 446/219; 446/137; 446/175

(57) ABSTRACT

A toy with forest like ambiance created by reflective surfaces of a toy tray box panels and with wild animals arranged in an interactive manner with sounds include spellings of such animal, skillfully decorated by reflecting surfaces that enhances the forest like ambiance and wherein the reflecting surfaces are part of a game box tray which has a base and two or more vertical side panels that form a play area and the box tray with base and side panels has two or more reflecting surfaces that can be utilized fully or covered partially. Such coverings of the reflective surfaces can enhance the ambiance of the play area and such reflecting surfaces create a near infinite tunnel of objects placed in the near vicinity of such reflecting surfaces.

### CROSS REFERENCE TO RELATED APPLICATION

Application No. 61/429,161—Prior provisional application by self

Filed: Jan. 2, 2011—Prior provisional application filing date

Other cited references

| | | |
|---|---|---|
| 6,679,751 | January 2004 | Maxwell et al. |
| 7,238,026 | July 2007 | Brown et al. |
| 5,190,287 | March 1993 | Ishiyama |
| 4,936,780 | June 1990 | Cogliano |

### BACKGROUND OF THE INVENTION

1. Field of Invention

The present invention is in the technical field of toys. More particularly, the present invention is in the technical field of entertainingly learning toys helpful in developing various skills in kids. More particularly in blocks and parts putting together for assembly giving an audible feedback and a visual illusion based entertainment.

2. Related Art

There are many types of blocks and parts assembled toys which end up into buildings, landscapes, and animals such as Lego, Mechano or Mega blocks. There are also two dimensional animals used as puzzles, when placed in a board make some sounds.

Building blocks can be used anywhere and provide hours of creative fun through building. Some building blocks are simple cubes designed for stacking, while others are releasable fastened together by an interlocking mechanism, such as Lego blocks.

There are also many types of educational electronic talking toys which help toddlers learn colors, numbers, shapes, and the like. Some of these consist of a base unit and a number of additional objects which the base unit identifies when the object is placed in it. Some examples of the latter type of toy are. U.S. Pat. No. 5,190,287 of Ishiyama and U.S. Pat. No. 7,238,026 of Brown et al. One problem with some electronic talking toys is lack of creativity, such that they do not tend to capture a child's attention for extended periods of time.

Some building block toys are also designed to produce an audible output or “talk” to a child as the child plays with the blocks. For example, U.S. Pat. No. 4,936,780 of Cogliano describes alphabet blocks which produce a sound output when a face of the block is touched. The output may be music or any other entertaining sound.

These toys whether they are building blocks assembling into a city or the animals assembling into a jungle fail to provide the visual effect of enormity of the depth and width of a city or a forest. More so the animal shaped blocks when they are placed on the base station, make some kind of sounds but they lack in learning value of such sounds or music and lack proper correlation between their sounds and names. Further the conventional animal toys or group of such animals or blocks put together as a toy fail to give a fair look and size of a forest or a city.

### BRIEF SUMMARY OF THE INVENTION

The present invention is a sound generating interactive learning toy within a toy box tray with plurality of blocks that makes specific sounds related to the context of the block such as an animal when properly placed.

The uniqueness is in the toy box tray which creates a visual illusion that is created by mutually reflecting images, multiplying the number of blocks and showing near infinite depth of such environment, by two or more reflecting surfaces that are positioned in the toy box tray panels and the base.

The reflecting surfaces of the panels are so positioned that any object which can be a two dimensional such as a scene of forest or multi-dimensional such as a block or a figure of an animal placed in the vicinity of these panels will be multiplied by reflections and would create an infinite tunnel of objects or such scene.

### BRIEF DESCRIPTION OF THE DRAWINGS

FIG. 1 is a perspective view of toy box tray of the present invention, with base and side panels closed.

FIG. 2 is a perspective view of a toy box tray with one of the side panels open.

FIG. 3 is a perspective view of a toy box tray with three of the side panels open and laid down and showing the base.

FIG. 4 is generic front view of the toy box tray with three of the side panels open and erected forming side walls.

FIG. 5 is a perspective view of toy box tray of the present invention, side panels erected and the base lifted, showing the under lying electronic light and sound module

FIG. 6 is an isometric view of a generic block showing window openings to pass light and sound

FIG. 7 is a typical animal block representation sketch

FIG. 8 is a typical light source with a sound activation

FIG. 9 is a typical flyover blocks assembly-plan view

FIG. 10 is a typical flyover blocks assembly-elevation

### DETAILED DESCRIPTION OF THE INVENTION

Certain embodiments as disclosed herein provide for a learning toy set comprising a game box tray that has at least one base and at least two vertical side panels and plurality of two or three dimensional play objects which can be assembled by a child, at least some of the blocks producing a sensory output such as an audible or visual output when activated a sound or light switch.

After going thru this description it will become apparent to one skilled in the art how to implement the invention in various alternative embodiments and alternative applications. However, although various embodiments of the present invention will be described herein, it is understood that these embodiments are presented by way of example only, and not limitation.

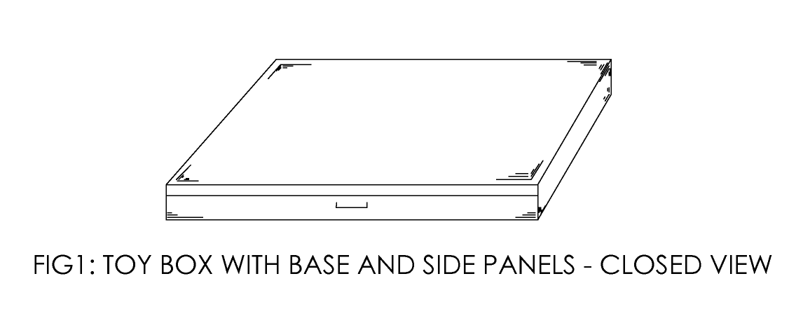

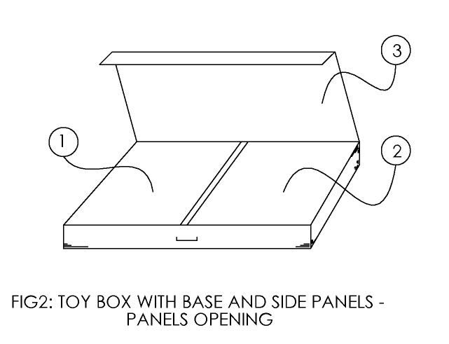

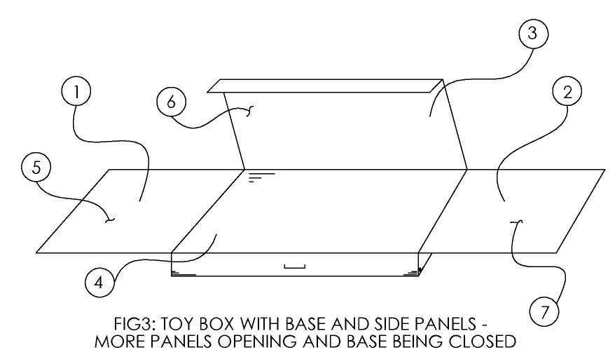

FIG. 1. Illustrates the toy tray as in its closed condition. The toy tray as illustrated can have any number of sides or can be circular or semicircular or such similar shapes. As illustrated from FIGS. 2 to 4 the side panels can be opened and closed temporarily and can be erected temporarily or permanently.

FIG. 2. Illustrating the side panels 1, 2 and 3. While panel 3 being shown as opened the panels 1 and 2 are still being closed.

FIG. 3. Illustrating the toy tray being opened and the side panels opened and temporarily lying down. Further FIG. 3. Illustrates the reflecting surfaces 5,6 and 7 on the side panels 1, 2 and 3. FIG. 3. also illustrates the base 4 which is capable of receiving any blocks or play objects such as but not limited to bridges, flyovers, cars, animals, fountains, volcanos, hills, rocks, rockets, roads, trees, figures of military personal, hangers, planes and so on.

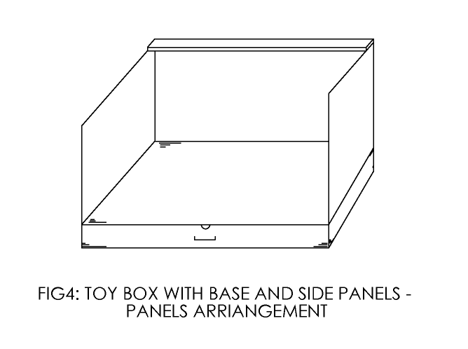

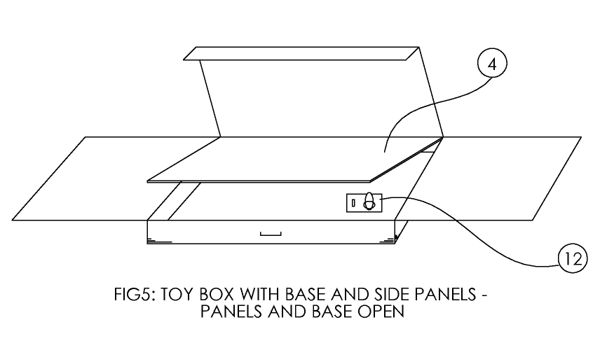

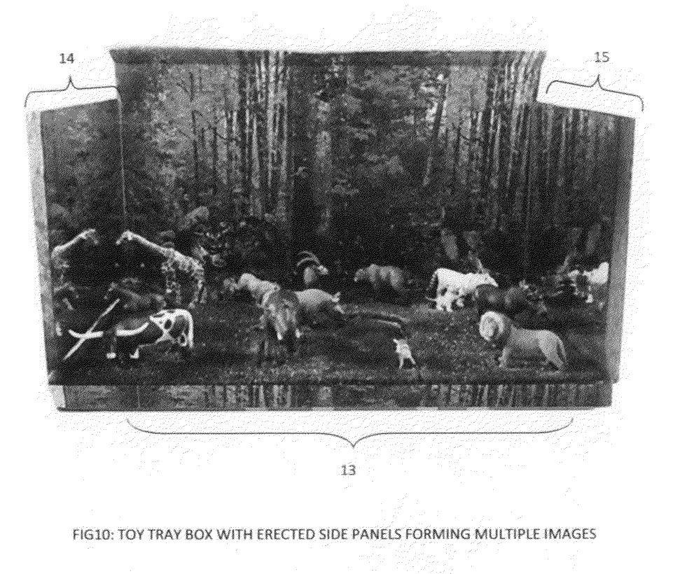

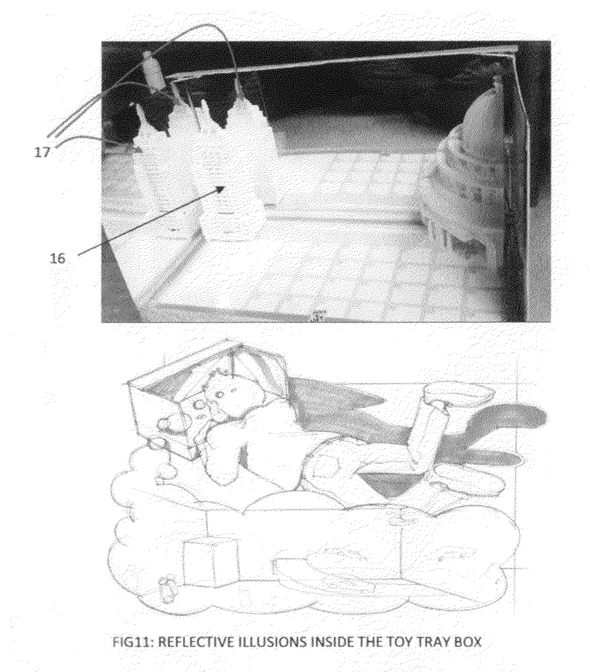

FIG. 4. Illustrates the erected side panels. These side panels can be erected by known means of magnetic attachments, hook and loop or any such means and by means embedded internally within those panels and base or by external means. Such panels having at least two reflecting surfaces can be so arranged to reflect images into each other and hence producing a virtually unending series of images that enhances the playing experience. Such panels can be partially or fully covered with scenes such as a skyline, landscape, forest or a canyon which in turn will by multiplied by the reflecting surfaces and produces width and depth of the play field as illustrated in FIG. 10 and FIG. 11.

FIG. 5. Illustrates the toy tray box base 4 being opened and illustrates a storage space underneath which the sound, light with sound activation arrangements 12, can be provided.

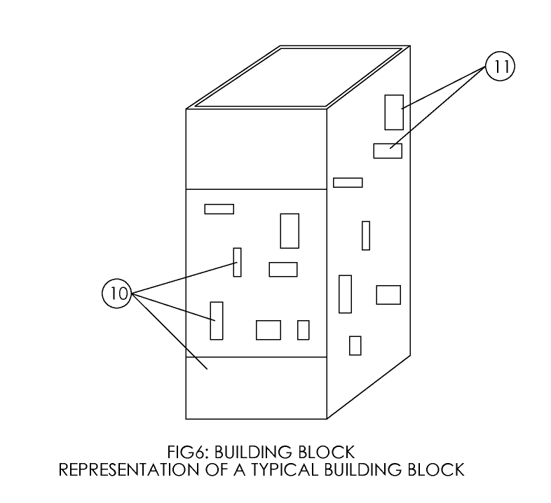

FIG. 6. Illustrates a generic building block but with windows 10 and 11 that are of any suitable shape and sizes would provide access to the light and sound to pass thru thus enhancing the visual experience of the building blocks. Once the building is completed by assembling various blocks put together a sound such as a clap by the kids can activate the sound activated switch placed either inside one of such blocks or underneath the base 4 in which case, the base can be provided with perforations to allow the clap sound to pass thru and activate such switch and light and sound arrangement 12 shown in FIG. 5.

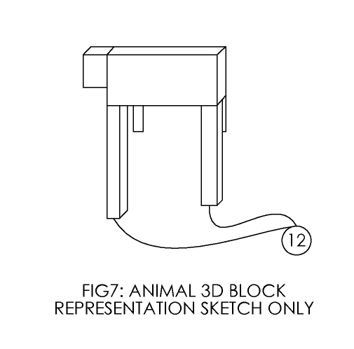

FIG. 7. illustrates a generic animal shaped block or animal figure with base 12 that can be placed on the toy tray box base 4.

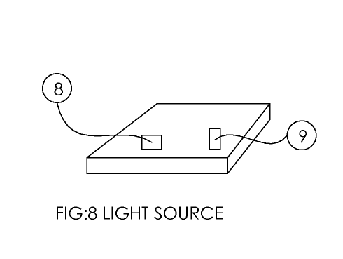

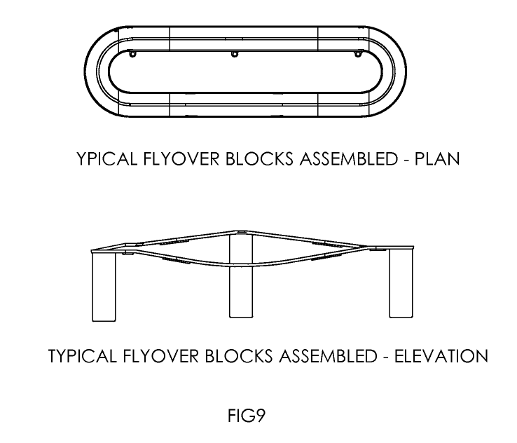

FIG. 8. Illustrates a light source that can be activated by a sound switch or such mechanism 8 and a light source 9.

FIG. 9. Illustrates an assembly of blocks that create a flyover or a kind of bridge which can be placed in between reflecting surfaces 5, 7 and 3 shown in FIG. 3 and the reflections thus made by such surfaces provide an illusion of having more than one tracks and when a car being placed and rolled by the kid will look like two cars traveling in two different lanes and when taking turns provide an illusion of two cars exiting in two different directions.

FIG. 10 and FIG. 11 are pictorial illustrations of near infinite dimensions of the forest in FIG. 10 and the city in FIG. 11. The parts thus shown as 13 in FIG. 10. Is actual and the 14 and 15 are reflections that prolong to the depths infinite, as the kid's small head peeps into the toy tray box and in FIG. 11 a single building built by blocks 16 is reflected into about six buildings as marked by 17 in FIG. 11.

The above description of the disclosed embodiments is provided to enable any person skilled in the art to make or use the invention. Various modifications to these embodiments will be apparent to those skilled in the art and the generic principles described herein can be applied to other embodiments without departing from the spirit or scope of the invention. Thus it is to be understood that the description and the drawings presented herein represent a presently preferred embodiment of the invention and are therefore representative of the subject matter which is broadly contemplated by the present invention. There are many other forms and thus embodiments that can be easily created by one who is in the art. It is further understood that the scope of the present invention fully encompasses other embodiments that may become obvious to those skilled in the art.

The invention claimed under following claims:

1. A three dimensional learning toy block assembly comprising a game tray that has at least one base and at least two vertical side panels and plurality of two or three dimensional play objects. Game tray has at least two reflecting surfaces and such surfaces are so arranged that the objects placed in the vicinity of such surfaces would reflect multiple images of such objects to create an illusion of having infinite or multiple objects than the actually placed object or objects. Such images reflected multiple times in the said reflecting surfaces create endless tunnel of the environment such as infinitely deep jungle or city or landscape and such objects that are placed in the vicinity of said reflecting surfaces can be of two dimensional or three dimensional. These reflecting surfaces can be partially covered and such covering may enhance the playing experience or can meet other such illusion purposes. Such vertical panels and base can be temporarily be re-arranged or stacked together for conveniences such as packaging, transportation, shelf spacing and so. Such base of the tray independently or with help of side panels or by means and methods known to industry such as just by gravity weight of the objects, magnetic surfaces, by slots and mating projections or by hook and loop and so, is capable of retaining such objects being placed on the base.

2. The said three dimensional objects placed in the vicinity of the such reflecting surfaces can be animals and such animals are placed on the base and when proper animal is placed in proper place on the base will trigger a sound that is related to that animal pronouncing in one or more languages that animal's name and spelling and that animal specific sound such as a trumpet for elephant. Such three dimensional animal blocks can be moving according to the sounds that the said block makes.

3. The three dimensional object can be at least one block of a building; Such block with windows and doors like recesses that can allow the light to pass; Such block can be illuminated and such illumination can be switched on and off. Such on and off switch can be operated by clapping sound or by any such sound. Such illumination can be one or more colors and these colors can be changing. And such blocks comprise at least one block that is in part or in full represent a building or part of a building or a bridge or flyover or such parts of a city or land scape. Such building blocks that are representing a part of a building are so arranged that the reflections created by the toy try reflecting surface, make an illusion of having a full building such as a quarter of a Capital building blocks can be arranged creating an illusion of a full Capital building being present. And such reflections may create an illusion of a full city with multiple buildings. Such blocks may represent any natural or man made objects.
